(19) United States
(12) Patent Application Publication
(10) Pub. No.: US 2001/0031338 A1
(43) Pub. Date: Oct. 18, 2001

(54) Box reinforcing sheet with self-stick layer

(76) Inventor: Sil Han, Wilmette, IL (US)

Correspondence Address: Leighton K. Chong, Ostrager Chong & Flaherty (Hawaii), Suite 1200, 841 Bishop Street, Honolulu, HI, 96813, US

(21) Appl. No.: 09/843,655

(22) Filed: Apr. 25, 2001

Related U.S. Application Data
(60) Provisional application No. 60/199,884, filed on Apr. 26, 2000.

(51) Int. Cl. B32B 3/28

(52) U.S. Cl. 428/174

(57) ABSTRACT

A reinforcing sheet structure for reinforcing a box has a structural base sheet of high shear strength and an extended length and width dimension equal to major parts of at least two of the box length, width, and height dimensions, and a double-sided adhesive layer having an extended length dimension corresponding to a major part of one of the base sheet's length and width dimensions. In one embodiment, the reinforcing sheet structure includes a plywood sheet and an intermediate corrugated sheet bonded to the plywood sheet. The adhesive layer is a double-sided foam tape. In another embodiment, the sheet structure has at least one fold line for folding the sheet structure into two parts for reinforcing over a fold line between adjacent sides of a box. The reinforcing sheet structure may be used in multiple combinations both inside and outside the box.

This patent application claims the priority benefit of U.S. Provisional Application 60/199,884 of the same inventor filed on Apr. 25, 2000.

### TECHNICAL FIELD

This invention generally relates to boxes and packaging materials, and particularly, to a reinforcing sheet with a self-stick layer for reinforcing boxes.

### BACKGROUND OF INVENTION

When packaged goods are relatively small but very heavy, one must often use a large box size that has a reinforced structure to accommodate the weight of the goods. This requires a lot of packing material or voluminous spacer material to be used to take up the unused space, as well as increased costs and inconvenience for shipping and handling. The present invention seeks to solve this problem by allowing smaller boxes to be used even when they do not have an adequate structure to handle heavier goods.

### SUMMARY OF THE INVENTION

In accordance with the invention, a sheet structure for reinforcing a box having opposing lateral, longitudinal, and top and bottom sides of given length, width, and height dimensions, comprises: a structural base sheet of high shear strength and an extended length and width dimension equal to major parts of at least two of the box length, width, and height dimensions, and a double-sided adhesive layer having an extended length dimension corresponding to a major part of one of the base sheet's length and width dimensions, wherein one side of said adhesive layer is adhered to a facing side of the base sheet, and the other side of said adhesive layer is adapted to be adhered to at least one of the lateral, longitudinal, and top and bottom sides of the box.

In one preferred embodiment, the reinforcing sheet structure includes a plywood sheet and an intermediate corrugated sheet bonded to the plywood sheet, and the adhesive layer is a double-sided foam tape. In another embodiment, the sheet structure has at least one fold line for folding the sheet structure into two parts, each of which is applied to one of two adjacent sides of the box, for reinforcing the box over a fold line between adjacent sides. The reinforcing sheet structure may be used in multiple combinations both inside and outside the box.

Other objects, features, and advantages of the present invention will be explained in the following detailed description of the invention having reference to the appended drawings.

### BRIEF DESCRIPTION OF DRAWINGS

FIGS. 1A, 1B, and 1C show top, front, and side views of one embodiment of a reinforcing sheet structure in accordance with the invention.

FIGS. 2A and 2B show another embodiment of a reinforcing sheet structure having a fold line for reinforcing a box over a fold line between adjacent sides.

FIGS. 3A and 3B show the sheet structure of FIG. 1 used to reinforce the inside of a standard box.

FIGS. 4A and 4B show multiple sheet structures of FIGS. 1 and 2 used in combination together to reinforce the inside of a standard box.

FIGS. 5A and 5B show multiple sheet structures used in combination together to reinforce the inside of a standard box against an object having sharp edges.

### DETAILED DESCRIPTION OF INVENTION

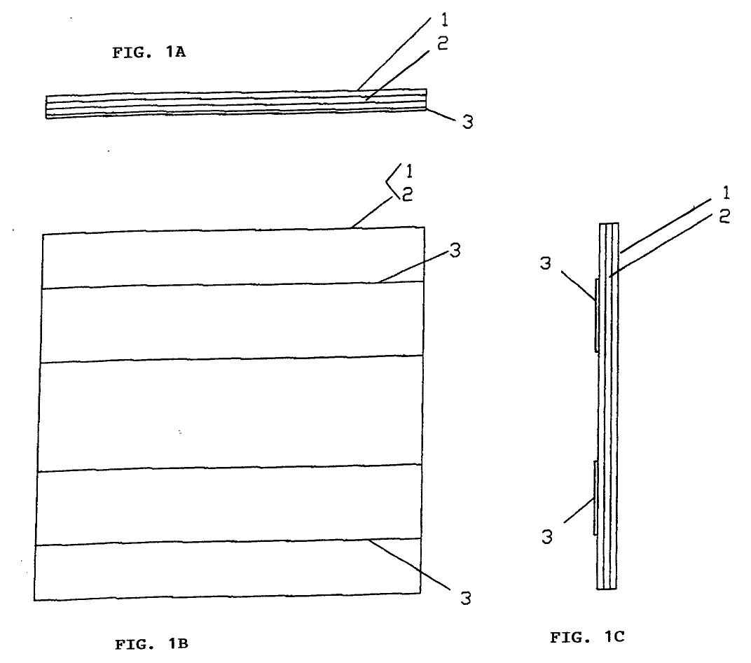

FIGS. 1A-1C show one embodiment of a sheet structure for reinforcing a box. The typical box has opposing lateral, longitudinal, and top and bottom sides of given length L, width W, and height dimensions D. The reinforcing sheet structure has a structural base sheet of high shear strength and an extended length and width dimension equal to major parts of at least two of the box length, width, and height dimensions. In this embodiment, the base sheet is a composite of a plywood sheet 1 having high structural rigidity and durability, and an intermediate corrugated sheet 2 for deformation strength and impact absorption bonded to the plywood sheet.

A double-sided adhesive layer 3 has an extended length dimension corresponding to a major part of one of the base sheet's length and width dimensions. One side of the adhesive layer 3 is adhered to a facing side of the base sheet, and the other side of the adhesive layer is to be adhered to one of the sides of the box. The adhesive layer may be, for example, a double-sided foam tape.

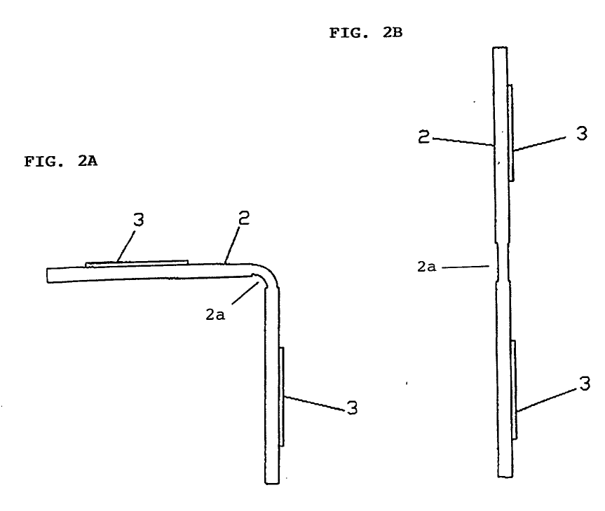

In FIGS. 2A and 2B, another embodiment of the reinforcing sheet structure has a corrugated sheet 2 and an adhesive layer 3, and a fold line 2a. The fold line allows the sheet structure to be folded into two parts, each of which is applied to one of two adjacent sides of the box, for reinforcing the box over a fold line between adjacent sides.

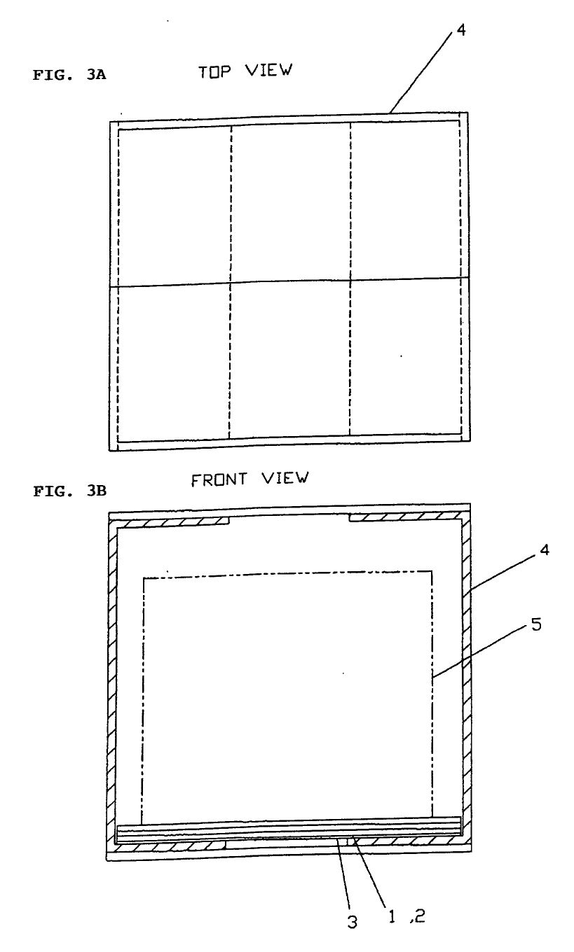

The reinforcing sheet structure may be used in multiple combinations both inside and outside the box. FIGS. 3A and 3B show the sheet structure (1, 2, 3) of FIG. 1 used to reinforce the inside of a standard box 4 positioned as a buffer between the bottom side of the box and a heavy object 5 packaged inside the box.

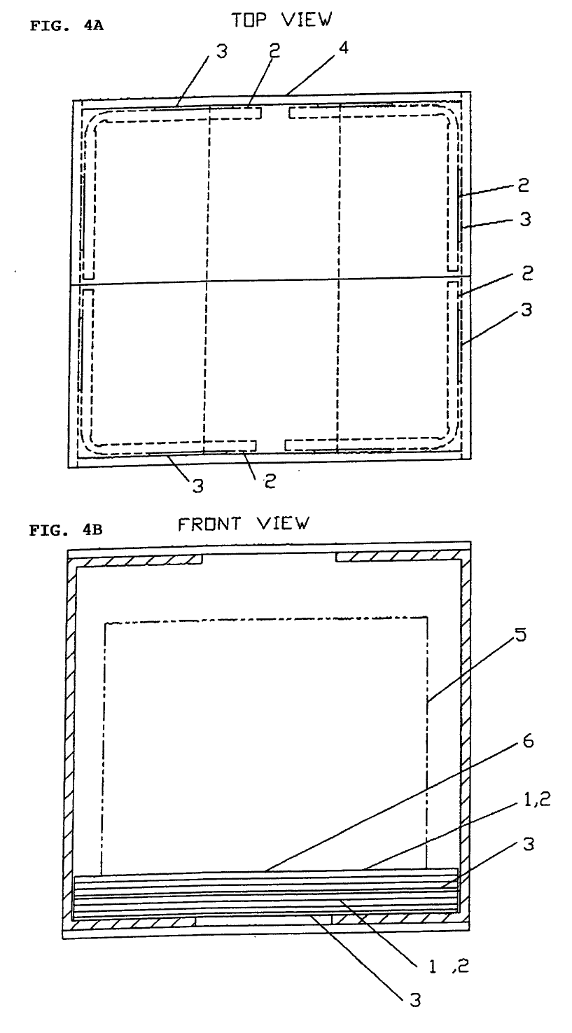

FIG. 4A shows four of the sheet structures (2, 3) of FIG. 2 used to reinforce the four fold lines across the four lateral and longitudinal sides of the box 4. FIG. 4B shows two of the sheet structures (1, 2, 3) of FIG. 1 used together to reinforce and buffer the bottom side of the box from a heavy object 5 resting on the sheet structures (as indicated by reference numeral 6).

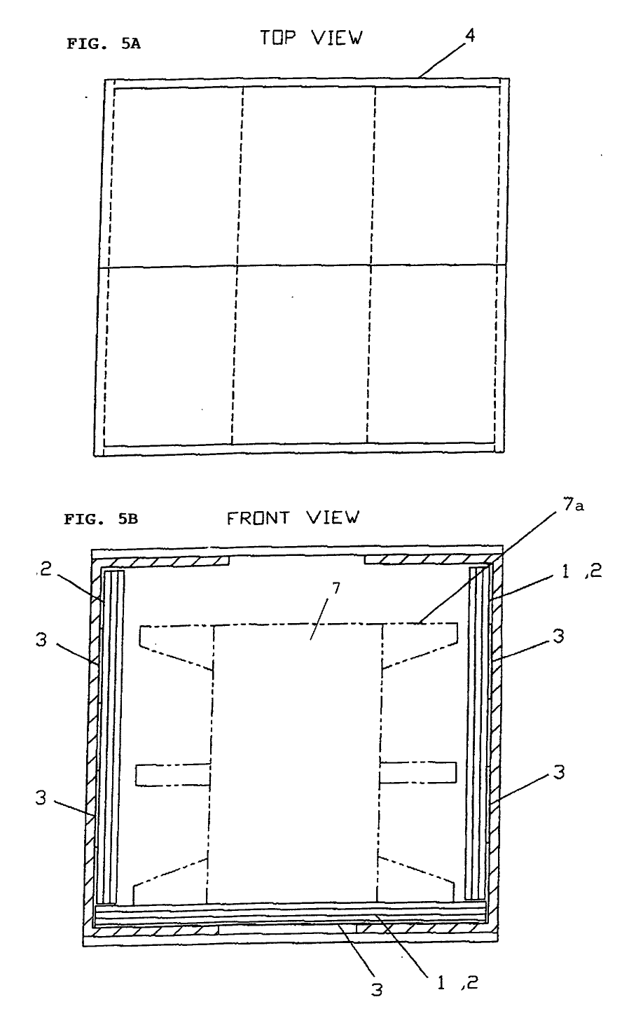

FIGS. 5A and 5B show multiple sheet structures (1, 2, 3) of FIG. 1 used in combination together to reinforce the inside lateral (and longitudinal) and bottom sides of the box against a heavy object 7 having sharp edges 7a.

It is understood that many modifications and variations may be devised given the above description of the principles of the invention. It is intended that all such modifications and variations be considered as within the spirit and scope of this invention, as defined in the following claims.

I claim:

1. A sheet structure for reinforcing a box having opposing lateral, longitudinal, and top and bottom sides of given length, width, and height dimensions, comprising:
a structural base sheet of high shear strength and an extended length and width dimension equal to major parts of at least two of the box length, width, and height dimensions, and a double-sided adhesive layer having an extended length dimension corresponding to a major part of one of the base sheet's length and width dimensions, wherein one side of said adhesive layer is adhered to a facing side of the base sheet, and the other side of said adhesive layer is adapted to be adhered to at least one of the lateral, longitudinal, and top and bottom sides of the box.

2. A reinforcing sheet structure according to claim 1, wherein the base sheet includes a plywood sheet and an intermediate corrugated sheet bonded to the plywood sheet.

3. A reinforcing sheet structure according to claim 1, wherein the adhesive layer is a double-sided foam tape.

4. A reinforcing sheet structure according to claim 1, wherein the sheet structure has at least one fold line for folding the sheet structure into two parts, each of which is applied to one of two adjacent sides of the box, for reinforcing the box over a fold line between adjacent sides.

5. A reinforcing sheet structure according to claim 1, wherein the reinforcing sheet structure is used in combination with other reinforcing sheet structures.

6. A reinforcing sheet structure according to claim 1, wherein the reinforcing sheet structure is used inside or outside the box.

7. A reinforcing sheet structure according to claim 1, wherein four reinforcing sheet structures are used to reinforce four fold lines across four lateral and longitudinal sides of a box.

8. A reinforcing sheet structure according to claim 1, wherein multiple reinforcing sheet structure s are used together to reinforce and buffer a side of the box from a heavy object packaged inside the box.
